(19) United States
(12) Patent Application Publication
(10) Pub. No.: US 2015/0181123 A1
(43) Pub. Date: Jun. 25, 2015

(54) IMAGE ORIENTATION ADJUSTMENT BASED ON CAMERA ORIENTATION

(71) Applicant: LYVE MINDS, INC., CUPERTINO, CA (US)

(72) Inventors: Mihnea Calin Pacurariu, Cupertino, CA (US); David Hoenig, Cupertino, CA (US); Andreas von Sneidern, Cupertino, CA (US)

(73) Assignee: LYVE MINDS, INC., CUPERTINO, CA (US)

(21) Appl. No.: 14/135,568

(22) Filed: Dec. 19, 2013

(51) Int. Cl. H04N 5/232; H04N 5/14

(52) U.S. Cl. CPC H04N 5/23264; H04N 5/14

(57) ABSTRACT

Systems and methods are disclosed to rotate an image recorded by an image sensor to compensate for angular rotation or tilt of the image sensor. For example, a camera can include an image sensor having a plurality of pixels arranged in an array, an accelerometer, a memory, and a processing unit. The processing unit can be configured to read a first plurality of pixels corresponding to an imaging area of the image sensor. The processing unit can also be configured to receive an acceleration value from the accelerometer, and determine an tilt angle value from the acceleration value that represents at least in part the tilt of the image sensor relative to the Earth's gravitational field or the horizon. The processing unit may also be configured to rotate at least a subset of the first plurality of image pixels of the image sensor based on the tilt angle value.

### FIELD

This disclosure relates generally to image orientation adjustment based on camera orientation.

### BACKGROUND

Digital video is becoming as ubiquitous as photographs. The reduction in size and the increase in quality of video sensors have made video cameras more and more accessible for any number of applications. Mobile phones with video cameras are one example of video cameras being more and accessible and usable. Small portable video cameras that are often wearable are another example. The advent of YouTube, Instagram, and other social networks has increased users' ability to share video with others.

### SUMMARY

Systems and methods are disclosed to correct an image or video frame recorded from an image area of an image sensor to compensate for tilt of the image sensor. A system can include an image sensor having a plurality of image sensor elements arranged in an array, an accelerometer, a memory, and a processing unit coupled with the image sensor, the accelerometer, and the memory. The processing unit may be configured to receive an image from the image sensor. The image may comprise a plurality of pixels each of which may comprise a value received from a corresponding image sensor element of the image sensor. The processing unit may also be configured to receive a value from the accelerometer that corresponds at least in part to an orientation of the image sensor relative to the Earth's gravitational field. The processing unit may then rotate the pixels in the image based on the value.

Another embodiment described herein includes a method that includes receiving an image from an image sensor wherein the image comprises a plurality of pixels that comprise a value received from a corresponding image sensor element of the image sensor; receiving a value from an accelerometer that corresponds at least in part to an orientation of the image sensor relative to the Earth's gravitational field; and rotating the pixels in the image based on the value.

In yet another embodiment a method may include reading a first video frame from an image sensor; storing the first video frame in a memory; receiving a first value from a sensor; and determining a first tilt angle value from the first value that represents the tilt of the image relative to the horizon; storing the first tilt angle value in the memory. The method may also include reading a second video frame from the image sensor; storing the second video frame in the memory; receiving a second value from the sensor; determining a second tilt angle value from the second value that represents the tilt of the image sensor relative to the horizon; and storing the second tilt angle value in the memory.

In yet another embodiment a method may include receiving a tilt value from an accelerometer; determining a tilt angle value from the tilt value; receiving a plurality of video frames from an image sensor; and rotating each of the plurality of video frames based on the tilt angle value.

In yet another embodiment a method may include reading a first video frame from an image sensor; storing the first video frame in memory; receiving a first acceleration value from an accelerometer; determining a first tilt angle value from the first acceleration value that represents the tilt of the image sensor relative to the Earth's gravitational field or relative to the horizon; and storing the first tilt angle value in the memory. The method may also include reading a second video frame from an image sensor; storing the second video frame in the memory; receiving a second acceleration value from the accelerometer; determining a second tilt angle value from the second acceleration value that represents the tilt of the image sensor relative to the Earth's gravitational field or relative to the horizon; and storing the second tilt angle value in the memory.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings.

FIG. 1A illustrates an example of a camera according to some embodiments described herein.

FIG. 1B illustrates an example of the camera in FIG. 1A tilted relative to the horizon according to some embodiments described herein.

FIG. 2 illustrates an example block diagram of an imaging system according to some embodiments described herein.

FIG. 3 illustrates a graphical representation of a sensor array and a field of view according to some embodiments described herein.

FIG. 4A illustrates a graphical representation of a sensor array and a reduced area of the image area according to some embodiments described herein.

FIG. 4B shows an tilt angle vector of the sensor array according to some embodiments described herein.

FIG. 4C shows a gravity vector according to some embodiments described herein.

FIG. 5A illustrates a graphical representation of the sensor array that is tilted relative to the gravitational field and a reduced area of the image area according to some embodiments described herein.

FIG. 5B shows an tilt angle vector of the sensor array according to some embodiments described herein.

FIG. 5C shows a gravity vector according to some embodiments described herein.

FIG. 6 illustrates an example flowchart of a process for saving an image along with inclination data according to some embodiments described herein.

FIG. 7 illustrates an example flowchart of a process for rotating video frames saved with acceleration data according to some embodiments described herein.

FIG. 8 illustrates an example flowchart of a process for rotating the image area prior to saving the image area according to some embodiments described herein.

FIG. 9 shows an illustrative computational system for performing functionality to facilitate implementation of embodiments described herein.

FIG. 10A illustrates an example of a camera with a rotatable camera core according to some embodiments described herein.

FIG. 10B illustrates an example of a rotatable camera core and a camera housing according to some embodiments described herein.

### DETAILED DESCRIPTION

Systems and methods are disclosed to correct a tilted image or video frame recorded from an image area on an image sensor if a camera based on data representing the orientation of the image sensor according to some embodiments described herein. The orientation data may include raw or processed data from an accelerometer, gyroscope, and/or magnetometer. In some embodiments, the orientation data may be compared with the horizon and/or a gravity vector and used to mathematically rotate the recorded image area as the image is being sampled from the image sensor, as the image is being saved into memory, or during post processing.

For example, the camera may be mounted at an angle relative to the Earth's gravitational field. Such a tilted camera will also have a tilted image sensor array that records tilted images or videos. Orientation data may be received from an accelerometer and used to correct the tilt in the image. Moreover, in some embodiments, an image area may be defined from the orientation data that includes a number of image sensing elements that are tilted relative to the image sensor array. The pixels within the image area may define a corrected image. In some embodiments, image sensor elements outside the image area may not be recorded. And in other embodiments, pixels of the image outside the image area may be cropped out of the image during post processing.

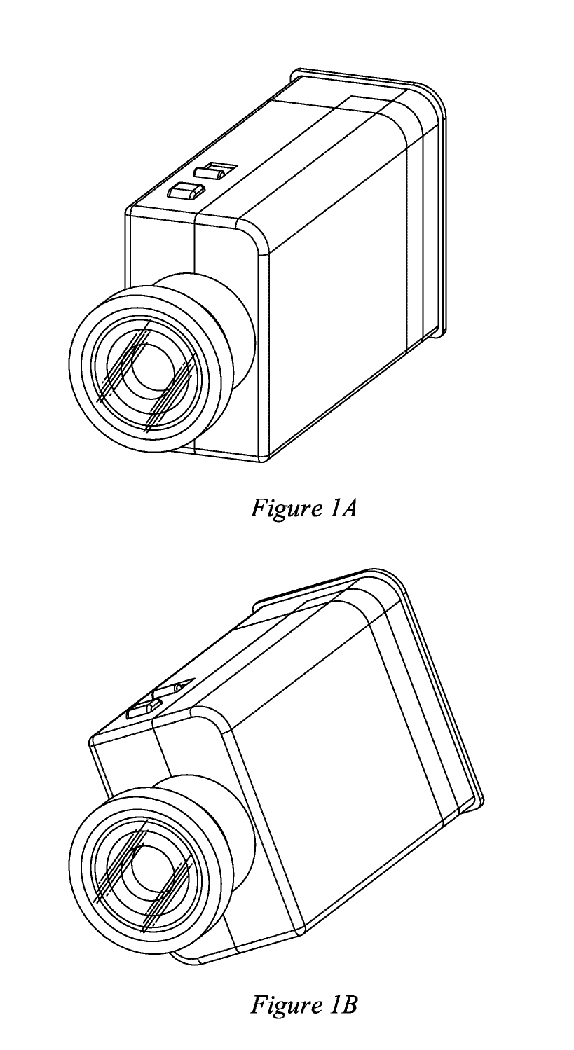

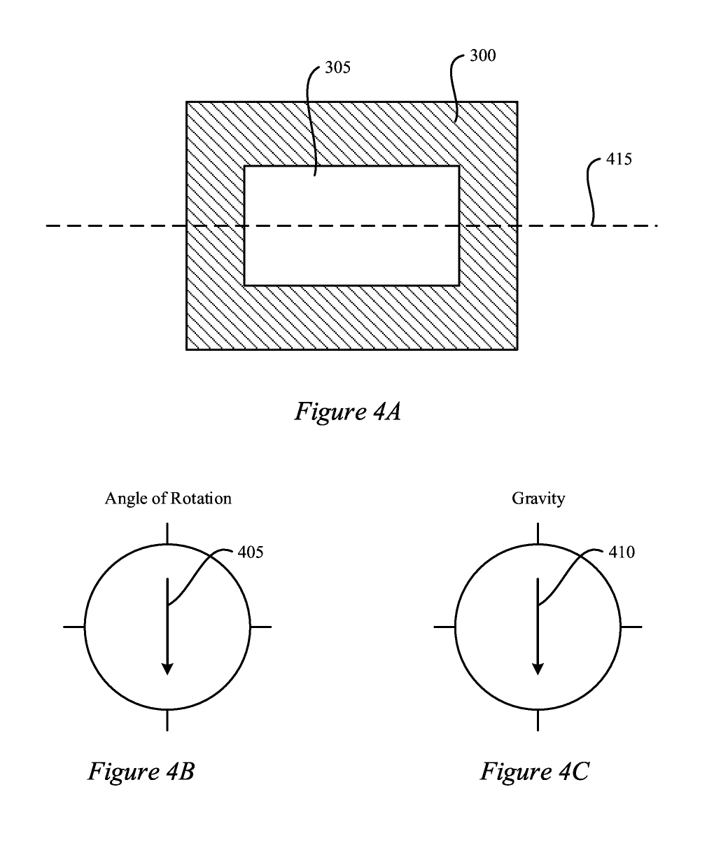

FIG. 1A illustrates an example of a camera 100 according to some embodiments described herein. The camera 100 is aligned with the horizon and/or the Earth's gravitational field such that images collected by the camera 100 may be properly aligned with the horizon. For example, FIG. 4A shows image sensor array 300 within the camera 100 aligned with the horizon 415. Because image sensor array 300 is aligned with the horizon 415, images recorded by image sensor array 300 may also be aligned and may not need rotation, or tilt correction.

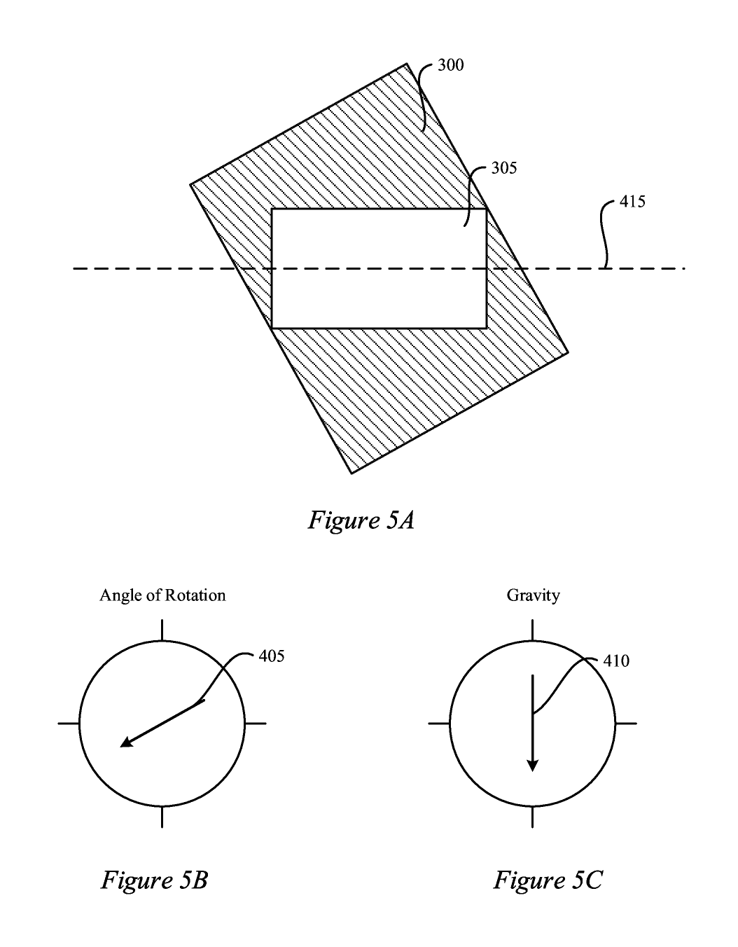

FIG. 1B, on the other hand, illustrates an example of the camera 100 rotated or tilted relative to the Earth's gravitational field. In FIG. 1B, the camera 100 is rotated such that images recorded by the camera 100 may not be aligned with the horizon and/or gravity. FIG. 5 shows image sensor array 300 within the camera 100 tilted relative with the horizon 415. In this way, for example, when the camera 100 is rotated or tilted as shown in FIG. 1B the images collected by image sensor array 300 may need to be corrected to compensate for the rotation or tilt of the camera 100. According to some embodiments described herein, the rotation, or tilt of images or video frames collected by the camera 100 may be corrected mathematically to provide images or video frames that are not tilted or rotated. Such images, for example, may be more pleasing for viewing. Moreover, as another example, such corrections may allow for the camera 100 to be tilted or rotated when mounted, and yet produce images or video frames that are not tilted or rotated.

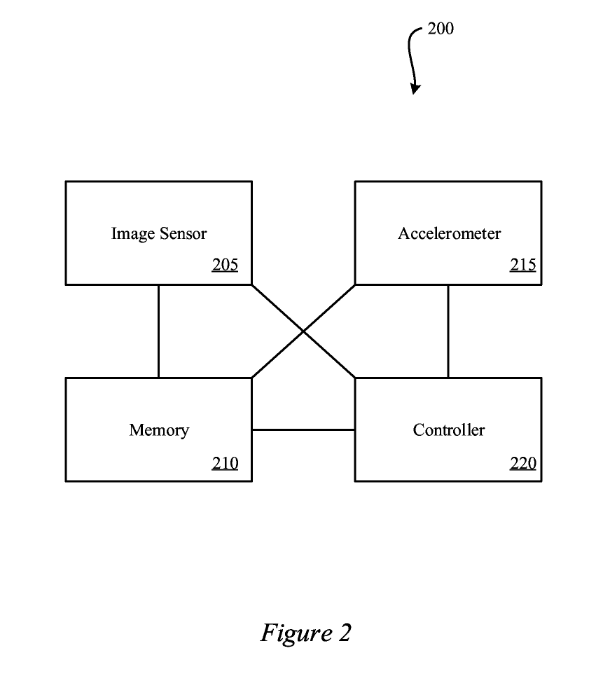

FIG. 2 illustrates an example block diagram of an imaging system 200 according to some embodiments described herein. The imaging system 200 may include a controller 220 communicatively coupled either wired or wirelessly with an image sensor 205, a memory 210, and/or an accelerometer 215. The imaging system components may be included within the camera core 110 and/or the camera housing 105. For example, the image sensor 205 and/or the accelerometer 215 may be included within the camera core 110 and/or the memory 210 and/or the controller 220 may be included within the camera housing 105. In some embodiments, the image sensor 205 and the memory 210 may also be electrically coupled so that images recorded by the image sensor 205 may be saved in the memory 210. The controller 220 may control the operation of the image sensor 205, the memory 210, and/or the accelerometer 215.

The image sensor 205 may include any device that converts an image represented by incident light into an electronic signal. The image sensor 205 may include a plurality of image sensor elements, which may be arranged in an array (e.g., a grid of image sensor elements). For example, the image sensor 205 may comprise a CCD or CMOS image sensor. The image sensor array may include a two-dimensional array with an aspect ratio of 1:1, 4:3, 5:4, 3:2, 16:9, 10:7, 6:5, 9:4, 17:6, etc., or any other ratio. In some embodiments, the image sensor array may be used that is large enough in both the vertical and horizontal directions that allow for image capture of an image area (or field of view) with any aspect ratio either rotated or not rotated. The image sensor array may produce an image having pixels such that each pixel corresponds with one or more image sensor elements. For instance, one pixel may correspond with different image sensor elements sensing the different color of the light.

The image sensor 205 may be optically aligned with various optical elements that focus light onto the image sensor array. Any number of image sensor elements may be included such as, for example, 8 megapixels, 15 megapixels, 20 megapixels, 50 megapixels, 100 megapixels, 200 megapixels, 500 megapixels, 1000 megapixels, etc. The image sensor 205 may collect images and/or video data.

The memory 210 may store images or portions of images recorded by the image sensor 205. The memory 210 may include volatile or non-volatile the memory, for example, DRAM memory, flash memory, NAND flash memory, NOR flash memory, etc., or any other type of memory. The memory 210 may also include software that may be executed by the controller 220.

The accelerometer 215 may be a one-axis accelerometer, a two-axis accelerometer or a three-axis accelerometer. A single-axis accelerometer 215 returns an acceleration value, Aₓ, that represents the acceleration of the camera along a single axis and may be used to determine the tilt angle of the accelerometer 215 relative to a reference position. The tilt angle, θ, can be determined from θ=sin⁻¹ Aₓ.

Alternatively, a two-axis accelerometer may be used that returns two acceleration values, Aₓ and A_{y}, representing the acceleration of the camera along two orthogonal axes. The tilt

angle, θ, may be determined from

$$θ = {tan}^{- 1} \frac{{A}_{x}}{{A}_{y}} .$$

Alternatively, two orthogonally placed single-axis accelerometers may be used instead of a two-axis accelerometer. The tilt angle, θ, may be determined in a similar manner. The accelerometer 215 may be coupled with the controller 220 and/or the memory 210. In some embodiments, acceleration data or tilt angle data may be saved in the memory as metadata associated with an image or each video frame. For example, for each image or video frame saved in the memory 210, a corresponding acceleration value or tilt angle value may be saved in the memory 210.

A three-axis accelerometer may also be used that returns three acceleration values, Aₓ, A_{y} and A_{z}, representing acceleration of the camera along three orthogonal axes. The tilt angle of tilt in the xy-plane (horizontal plan), θ, and the tilt angle of inclination from the gravity vector, φ, to the measured acceleration in each axis, as

$$θ = {tan}^{- 1} \frac{{A}_{x}}{{A}_{y}} and ϕ = {cos}^{- 1} ( \frac{{A}_{z}}{\sqrt{{A}_{x}^{2} + {A}_{y}^{2} + {A}_{z}^{2}}} ) .$$

If gravity is the only force on the accelerometer, then φ=cos⁻¹ (A_{z}) and represents the inclination relative to gravity.

Alternatively or additionally, a gyroscope may be used instead of or in conjunction with the accelerometer 215. The gyroscope may be used to detect the tilt angle or tilt of the camera relative to some reference. Moreover, the accelerometer 215 may include a six-axis sensor that includes both an accelerometer and a gyroscope. As another example, a nine-axis sensor may be used that includes an accelerometer, gyroscope, and/or a magnetometer, which measures the magnetic field of the Earth. The nine-axis sensor may output raw data in three axes for each individual sensor: acceleration, gyroscope, and magnetometer, or it can output a rotation matrix that describes the rotation of the sensor about the three Cartesian axes. The rotation tilt angle of the device relative to the Earth's gravitational field may be determined from this data.

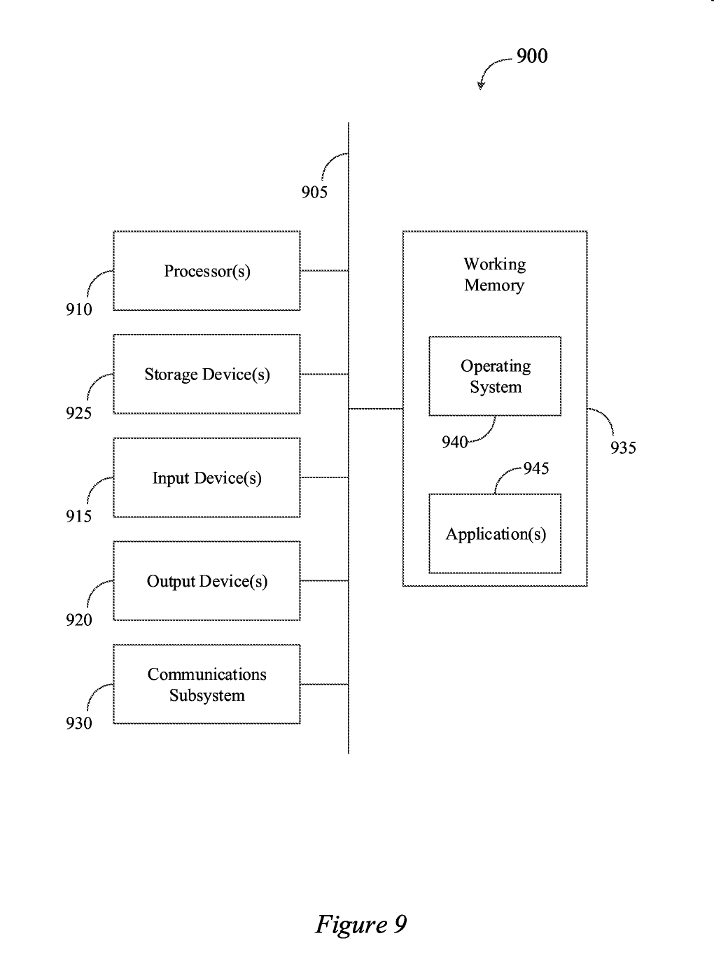

The controller 220 may, for example, include any or all components of computational system 900 shown in FIG. 9 or any other processor or processing unit. The controller 220 may control the operation of the image sensor 205, the memory 210, and/or the accelerometer 215 according to code saved in the memory 210 or the memory internal to the controller 220. The controller 220, for example, may instruct the image sensor 205 to start and/or stop collecting images (or video) and/or instruct the accelerometer 215 to collect acceleration data and store the data in the memory 210. The controller 220 may also be configured to perform many other operations.

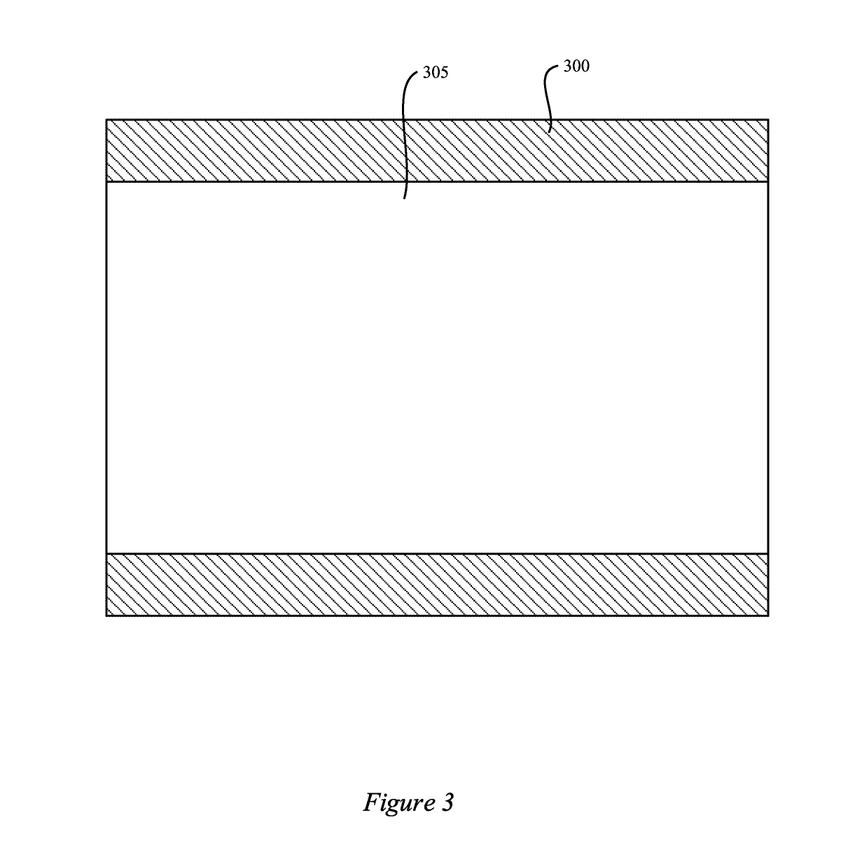

FIG. 3 illustrates a graphical representation of an image sensor array 300 and an image area 305 of the image sensor array 300 that defines a number of image sensor elements within the image sensor array according to some embodiments described herein. The image area 305, for example, may represent the portion of the field of view that the user would like recorded as an image or a video frame. In this example, the image sensor array 300 may include a 4:3 aspect ratio such that the number of image sensor elements along the vertical axis is three-fourths the number of image sensor elements along the horizontal axis and produces an image with a corresponding aspect ratio of pixels. In some embodiments, the image area 305 may be the area where an image is focused onto the image sensor array 300. The image area 305 may capture a scene being recorded by the camera. The image area 305 may have a different aspect ratio than the image sensor array 300. For example, the image area may have a 16:9 aspect ratio such that the number of image sensor elements along the vertical axis is nine-sixteenths the number of image sensor elements along the horizontal axis. Various other aspect ratios may be used. Moreover, the aspect ratio, size, position, and/or orientation of the image area 305 may be changed at any time. A image sensor array 300 of any size may be used that allows for image areas of any aspect ratio. Moreover, the aspect ratio may be changed in software or hardware. This change in aspect ratio, for example, may be dynamic.

Moreover, in this example, the image sensor array 300 and the imaging area 305 is aligned along the same horizontal and vertical axes so that the image area 305 may encompass as many horizontal image sensor elements of the image sensor array 300 as possible. The portions of the image sensor array 300 that are not part of the image area 305 may be cropped either in real time or in post procession, or the image sensor elements information may not be read from the sensor array when recording an image or video frame.

FIG. 4A illustrates a graphical representation of the image sensor array 300 with the image area 305 having a smaller size than the image area shown in FIG. 3A according to some embodiments described herein. In this example, the image area is reduced to compensate for future or potential rotations of the image area 305 relative to the image sensor array 300 or vice versa (see FIG. 5A). As shown, the image area 305 and/or the image sensor array 300 are aligned with the horizon 415.

FIG. 4B shows an tilt angle vector 405 of the image sensor array 300 and FIG. 4C shows a gravity vector 410. In this example, the tilt angle vector 405 of the image sensor array 300 is aligned with the gravity vector 410. The gravity vector, for example, may be retrieved from the accelerometer 215. The gravity vector is orthogonal with the horizon 415. The image sensor array 300 may be large enough to capture all aspect ratios of data when rotated or not rotated.

FIG. 5A illustrates a graphical representation of the image sensor array 300 that is tilted relative to the gravitational vector 410 and relative to the horizon 415. A reduced area of the image area 305 may be used to compensate for any rotation. In this example, the image sensor array 300 is tilted 60.8° relative to the gravitational field and 29.2° relative to the horizon 415. The size of the image area may depend on the size of the image sensor and/or the desired aspect ratio of the image area.

FIG. 5B shows the tilt angle vector 405 of the image sensor array 300 having a tilt of 60.8° relative to the gravitation field vector shown in FIG. 5C. As shown in FIG. 5A, despite the tilt of the image sensor array 300, a correction may be made in the image area 305 to provide an image that is not rotated or tilted. Thus, the image area 305 may be sized such that the image sensory array 300 may sample images and/or video frames regardless of the tilt or rotation of the image sensor array 300.

In embodiments described herein, image sensor elements of the image sensor array 300 not overlapped by the image area 305 may have light directed thereon from the optical elements of the system, yet only the image sensor elements overlapping the image area 305 may be considered the image area 305. The image sensor elements not covered by the image area 305 may be cropped. For example, this may be accomplished in a number of ways including, but not limited to, not recording values from these image sensor elements as the image is being recorded, cropping out the corresponding pixels in the image when the image is being saved into memory 210, and/or cropping out the corresponding pixels in the image during post process (e.g., using the controller 220). Regardless of the technic used, these portions may be cropped out using an algorithm or process executed by controller 220. In some embodiments, the image may be cropped to the image area 305 before or after any encoding.

For example, the image sensor elements of the image sensor array 300 not overlapping the image area 305 may have light focused thereon, may be imaged by the sensor, and may be saved in the memory 210 as part of an image or a video frame. During post processing, the corresponding pixels of the image may be cropped out leaving only the pixels corresponding to the image area 305 and with the image area properly oriented.

As another example, image sensor elements of the image sensor array 300 not overlapped by the image area 305 may not be imaged or read by the sensor array and the image area 305 may be rotated prior to saving the image into the memory 210. The controller 220, for example, may instruct the image sensor 205 to only activate and/or sample data from the image sensor elements overlapped by the image area 305. As yet another example, image sensor elements of the image sensor array 300 not overlapped by the image area 305 may have light focused thereon and may be imaged by the image sensor array 300, but data sampled from these image sensor elements may not be saved as part of the image.

In some embodiments described herein, the image area 305 may be cropped from all the pixels in a sampled image based on the tilt angle of tilt of the camera relative to the direction of the gravitation vector and/or the horizon based on readings from the accelerometer 215. The rotated image area 305 can be determined using any number of techniques, for example, matrix mathematics and/or bit masks, etc. Moreover, antialiasing techniques may be applied to the image during or after rotation.

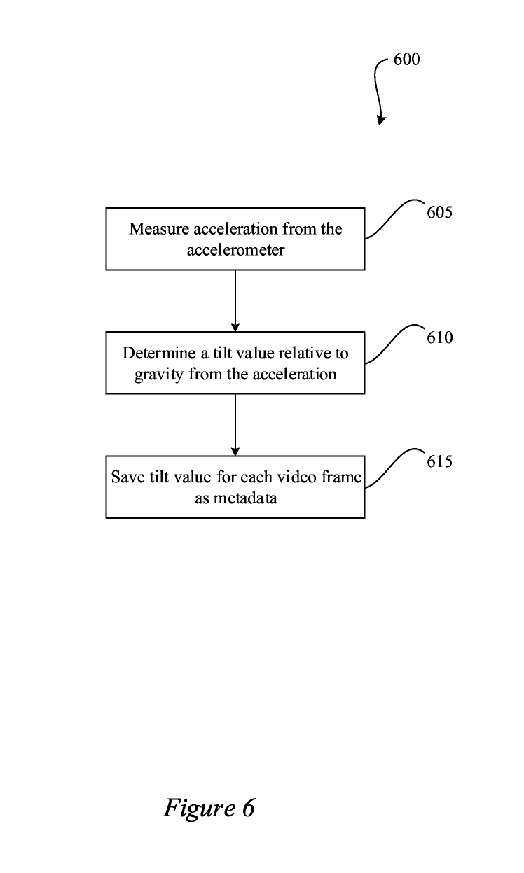

FIG. 6 illustrates an example flowchart of a process 600 for saving a video frame with inclination data according to some embodiments described herein. The process 600 starts at block 605. At block 605 acceleration data may be measured and/or recorded from the accelerometer 215. In some embodiments, the acceleration data may be filtered, amplified, digitized, or modified, for example, based on calibration data, etc.

At block 610 the tilt angle data of the image sensor array 300 within the camera may be determined based on the acceleration data. Moreover, the tilt angle data may specify the tilt of the sensor array relative to the gravitational field or to the horizon. For example, the tilt angle data may be determined using the equations described above or using any technique known in the art or specified by the accelerometer manufacturer.

At block 615 the tilt angle data may be saved with each video frame. The tilt angle data may be saved as metadata within a separate file or as part of each video frame. For example, if images from the image sensor array 300 are being saved at a rate of 24 frames per second, then tilt angle of inclination data may also be saved at this rate. As another example, the tilt may be determined less frequently than the image sensor array 300 data is saved and an average tilt or a sampled tilt may be saved with each image area. The sampled tilt may include tilt angle or rotation data sampled less often than the image sensor array 300 is sampled.

In some embodiments described herein, block 610 may be skipped and acceleration data and not tilt angle data may be saved with each image or video frame. In some embodiments, both the tilt angle data and the acceleration data may be saved with each image or video frame.

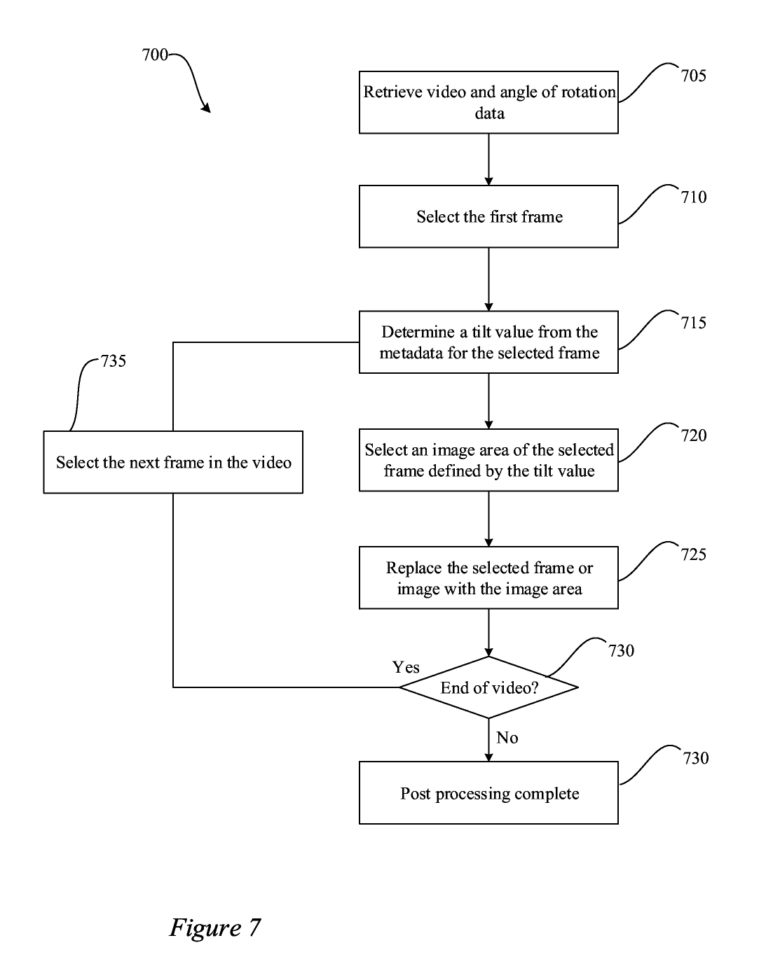

FIG. 7 illustrates an example flowchart of a process 700 for rotating the image area 305 of a plurality of video frames with acceleration data (or tilt angle data) during post processing according to some embodiments described herein. Process 700, for example, a processor may mathematical transform the image using matrix mathematics. The process 700 starts at block 705. At block 705 video data and metadata may be retrieved from the memory. The video data may include a plurality of frames. The metadata may include the acceleration data or tilt angle data for each frame or one or more frames. At block 710, the first frame may be selected.

At block 715 the tilt may be determined for the selected frame based on metadata. For example, if the metadata includes tilt angle data for each frame, then the tilt angle or rotation data may be retrieved. As another example, the metadata may include acceleration data and the tilt angle data may be determined using the equations described above or using any technique known in the art or specified by the accelerometer manufacturer. In some embodiments, the acceleration data and/or the tilt angle data may be retrieved from metadata data.

At block 720 the image area 305 defined by the tilt can be determined and then selected for the selected frame. For example, the pixels of the image corresponding to the image area 305 defined by the tilt may be cropped to exclude pixels outside of the image area 305 and/or the image area 305 may be rotated by the tilt.

At block 725 the cropped and/or rotated image area may replace the frame within the memory 210. At block 730 it can be determined whether the last frame has been reached. If not, then the process 700 proceeds to block 725 where the next frame in the video is selected. After which, the process 700 proceeds to block 715 and repeats until every frame has been operated on. At block 730 the post processing may be complete.

In some embodiments the process 700 may process a single image. For example, a single image may be considered a video with a single frame and the process 700 may proceed with the single frame or image without repeating.

Alternatively and/or additionally, in some embodiments at block 715 an initial tilt may be determined. For example, the tilt angle data or the acceleration data of the first frame or another selected frame may be set as the initial acceleration data. Then, at block 720 the image area 305 defined by the initial tilt may be selected for all the frames of the video instead of the image area 305 defined by the tilt of each frame. In some embodiments, the initial tilt may include the average tilt of a subset of frames, the average tilt of a subset of frames including and following the initial frame, a running average of the tilt angle data, and/or the average tilt angle data of all the frames for the video. Moreover, the tilt angle data may be filtered or smoothed using a Savitzky-Golay filter, local regression smoothing, smoothing spline, a Kalman filter, etc. on a plurality of the tilt angle data. Various other filters or smoothing algorithms may be used without limitation.

As another example, a single acceleration value may be used to tilt a plurality of video frames within a video or all the video frames with a video. For instance, the first acceleration value or an average of a plurality of first acceleration values may be used to rotate one or more videos within a video frame.

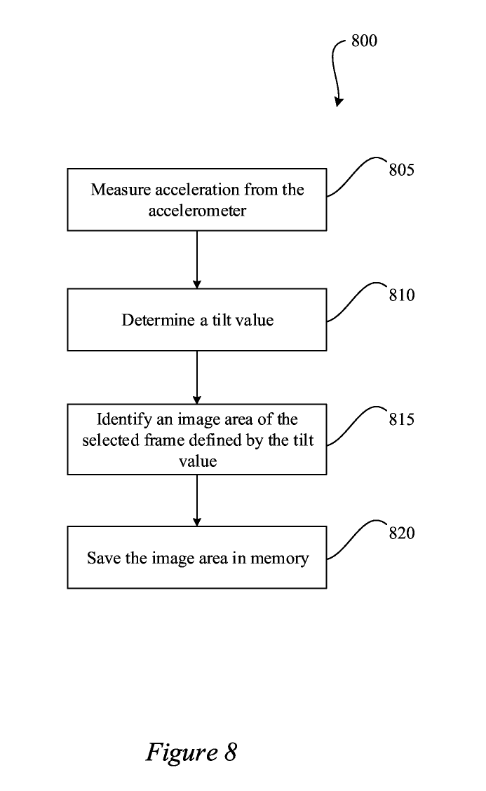

FIG. 8 illustrates an example flowchart of a process 800 for rotating the image area of a plurality of frames of a video prior to saving the video in the memory 210 according to some embodiments described herein. The process 800 starts at block 805. At block 805 acceleration data is received from the accelerometer 215. In some embodiments, the acceleration data may be filtered, amplified, digitized, or modified based on calibration data, etc. before, after, or during sampling.

At block 810 the tilt may be determined based on the acceleration data using the equations described above or using any technique known in the art or specified by the accelerometer manufacturer. At block 815 the image area 305 defined by the tilt on the image sensor 205 can be identified. An image of the image area 305 may then be saved into the memory 210. For example, the image may be cropped to only include the image area 305 and/or the image may be transformed based on the tilt angle data.

The process 800 may execute in real time as an image is read from the image sensor array 300 and saved into data. The image area 305 with tilt correction may be saved into data. If video frames are recorded at a rate of 24 frames per second, then the process 800 may be repeated at a rate of 24 frames per second. In some embodiments, the tilt angle data may also be saved in metadata along with each video frame. In other embodiments, a single tilt angle data may be used for a plurality of video frames.

In some embodiments the tilt angle data may be averaged over a selected period of time. The averaged tilt angle data may be used to identify and/or select the image area 305. For example, the tilt angle data may be averaged over the duration of the entire video. Then the average tilt may be used to rotate and/or crop each frame of the video.

As another example, the tilt angle data may be averaged as a running average over a selected period of time. For example, the tilt angle data may be averaged for a period of time (e.g., 1, 5, 10, 20, etc. seconds) or a number of frames (24, 50, 100, 200, 500, etc. frames) prior to or around a given video frame. The average tilt may be used to rotate the image area 305 of each video frame. The running average may be recalculated for each frame based on the running average.

Moreover, the tilt angle data may be filtered or smoothed using a Savitzky-Golay filter, local regression smoothing, smoothing spline, a Kalman filter, etc. on a plurality of the tilt angle data. Various other filters or smoothing algorithms may be used without limitation.

The computational system 900 (or processing unit) illustrated in FIG. 9 can be used to perform any of the embodiments of the invention. For example, the computational system 900 can be used alone or in conjunction with other components to execute all or parts of the processes 600, 700, and/or 800. As another example, the computational system 900 can be used to perform any calculation, solve any equation, perform any identification, and/or make any determination described here. The computational system 900 includes hardware elements that can be electrically coupled via a bus 905 (or may otherwise be in communication, as appropriate). The hardware elements can include one or more processors 910, including, without limitation, one or more general purpose processors and/or one or more special purpose processors (such as digital signal processing chips, graphics acceleration chips, and/or the like); one or more input devices 915, which can include, without limitation, a mouse, a keyboard, and/or the like; and one or more output devices 920, which can include, without limitation, a display device, a printer, and/or the like.

The computational system 900 may further include (and/or be in communication with) one or more storage devices 925, which can include, without limitation, local and/or network-accessible storage and/or can include, without limitation, a disk drive, a drive array, an optical storage device, a solid-state storage device, such as random access memory (“RAM”) and/or read-only memory (“ROM”), which can be programmable, flash-updateable, and/or the like. The computational system 900 might also include a communications subsystem 930, which can include, without limitation, a modem, a network card (wireless or wired), an infrared communication device, a wireless communication device, and/or chipset (such as a Bluetooth device, an 802.6 device, a WiFi device, a WiMax device, cellular communication facilities, etc.), and/or the like. The communications subsystem 930 may permit data to be exchanged with a network (such as the network described below, to name one example) and/or any other devices described herein. In many embodiments, the computational system 900 will further include a working memory 935, which can include a RAM or ROM device, as described above.

The computational system 900 also can include software elements, shown as being currently located within the working memory 935, including an operating system 940 and/or other code, such as one or more application programs 945, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 925 described above.

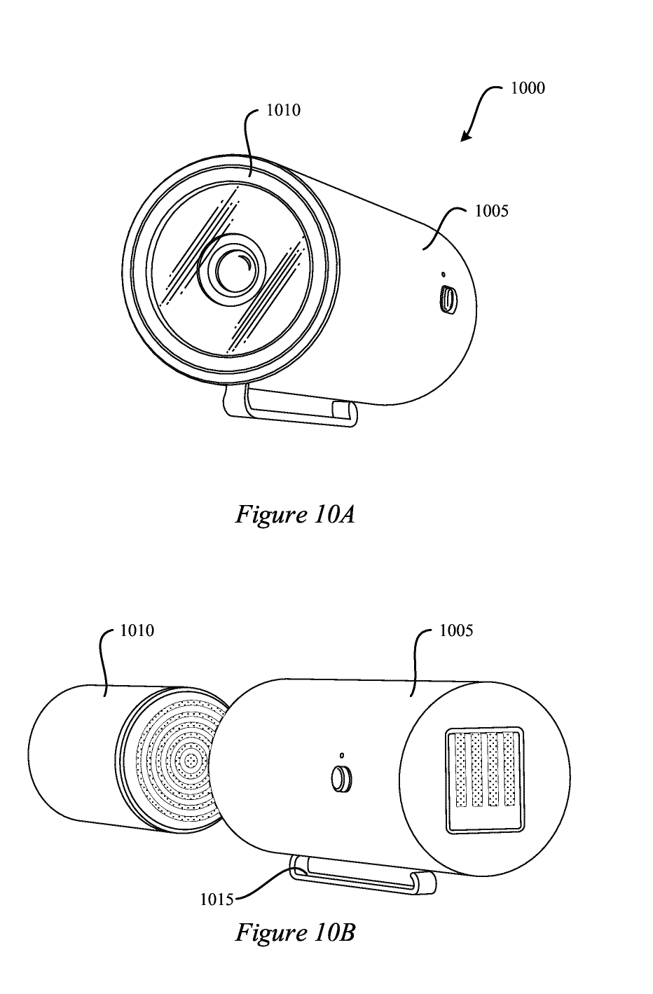

FIG. 10A illustrates an example the camera 1000 that includes a camera housing 1005 and a rotatable camera core 1010 that is removable and/or rotatable according to some embodiments described herein. Because the camera core 1010 is rotatable, embodiments of the invention may be used to compensate for rotations of the camera core 1010 relative to the gravity vector and/or the horizon and/or other tilts. The camera core 1010 may be cylindrically shaped and may be sized and configured to slide within a cylindrical cavity of the camera housing 1005. FIG. 10B illustrates the camera core 1010 extracted from the cylindrical cavity of the camera housing 1005. The camera core 1010 may include optical elements such as, for example, lenses, filters, holograms, splitters, etc., and an image sensor upon which an image may be recorded. Various other components may be included.

The camera housing 1005 may include a processing unit, a battery, memory, a user interface, a connector 1015, and/or various other components. The camera housing 1005 may also include the cylindrical cavity within which the camera core 1010 may slide in order to mate with the camera housing 1005. The connector 1015 may include any type of connector such as, for example, a clip, hook, bracket, attachment point, etc. that may be used to attach the camera housing with another object. Both the camera core 1010 and the camera housing 1005 may include various connectors and/or contacts for transferring data and/or power when connected.

Because the cavity within the camera housing 1005 is cylindrical and the camera core 1010 is also cylindrical, the camera core 1010 may rotate within the camera housing 1005. This rotation may allow the image sensor within the camera core 1010 to rotate around an axis parallel with the axis of the cylinder of the camera core 1010. Such configurations may cause the image sensor to have any rotational orientation while in use. Thus, unless the camera core 1010 is oriented by a user, the images produced by the image sensor will show a rotated field of view. Moreover, the camera housing 1005 may be attached to another object at an tilt angle using the connector 1015 that may also cause the image sensor to be misaligned. FIG. 5A shows an example of an image area (or field of view) superimposed on a rotated sensor array. As shown, this image area is rotated relative to the image sensor. Embodiments described herein may compensate for such rotations by rotating images recorded by the image sensor and/or cropping unused pixels in the image of the image sensor in real time, while being saved to memory, or during post processing (before or after encoding).

In some cases, the storage medium might be incorporated within the computational system 900 or in communication with the computational system 900. In other embodiments, the storage medium might be separate from the computational system 900 (e.g., a removable medium, such as a compact disc, etc.), and/or provided in an installation package, such that the storage medium can be used to program a general purpose computer with the instructions/code stored thereon. These instructions might take the form of executable code, which is executable by the computational system 900 and/or might take the form of source and/or installable code, which, upon compilation and/or installation on the computational system 900 (e.g., using any of a variety of generally available compilers, installation programs, compression/decompression utilities, etc.), then takes the form of executable code.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

That which is claimed:

1. A camera comprising:
an image sensor having a plurality of image sensor elements arranged in an array;
a motion sensor;
a memory; and
a processing unit coupled with the image sensor, the accelerometer, and the memory, the processing unit configured to:
receive an image from the image sensor, wherein the image comprises a plurality of pixels that comprise a value received from a corresponding image sensor element of the image sensor;
receive a value from the motion sensor that corresponds at least in part to an orientation of the image sensor relative to the Earth's gravitational field; and
rotate the pixels in the image based on the value.

2. The camera according to claim 1, wherein the value received from the accelerometer is an acceleration value and the processing unit is further configured to determine the value from the acceleration value.

3. The camera according to claim 1, wherein the processing unit is further configured to:
determine an image area based on the value; and
crop pixels outside the image area.

4. The camera according to claim 1, wherein the motion sensor comprises a three-axis accelerometer.

5. The camera according to claim 1, wherein the motion sensor comprises a nine-axis accelerometer that includes a gyroscope and a magnetometer.

6. The camera according to claim 1, wherein the processing unit is further configured to determine an average acceleration value by averaging a plurality of acceleration values over time, and wherein the value is determined from the average acceleration value.

7. The camera according to claim 1, wherein the processing unit is further configured to filter a plurality of acceleration values and wherein the value is determined from the filtered acceleration value.

8. The camera according to claim 1, wherein the processing unit is further configured to:
save the plurality of pixels in the memory as a video frame; and
save the value in the memory in association with the video frame;
wherein the rotating the pixels in the image based on the value occurs after the plurality of pixels are saved in memory.

9. A method for correcting tilt in an image, the method comprising:
receiving an image from an image sensor wherein the image comprises a plurality of pixels that comprise a value received from a corresponding image sensor element of the image sensor;
receiving a value from a motion sensor that corresponds at least in part to an orientation of the image sensor relative to a horizon; and
rotating the pixels in the image based on the value.

10. The method according to claim 9, wherein the motion sensor comprises at least one of an accelerometer and a gyroscope.

11. The method according to claim 9, wherein the value received from the motion sensor is an acceleration value and the method further comprises determining the value from the acceleration value.

12. The method according to claim 9, further comprising:
determining an image area based on the value; and
cropping pixels outside the image area.

13. The method according to claim 9, further comprising determining an average acceleration value by averaging a plurality of acceleration values over time, and wherein the value is determined from the average acceleration value.

14. The method according to claim 9, further comprising:
saving the plurality of pixels in the memory as a video frame; and
saving the value in the memory in association with the video frame;
wherein the rotating the pixels in the image based on the value occurs after the plurality of pixels are saved in memory.

15. A method comprising:
reading a first video frame from an image sensor;
storing the first video frame in a memory;
receiving a first value from a motion sensor;
determining a first tilt angle value from the first value that represents the tilt of the image relative to the horizon;
storing the first tilt angle value in the memory;
reading a second video frame from the image sensor;
storing the second video frame in the memory;
receiving a second value from the motion sensor;
determining a second tilt angle value from the second value that represents the tilt of the image sensor relative to the horizon; and
storing the second tilt angle value in the memory.

16. The method according to claim 15, further comprising:
transforming the first video frame based on the first tilt angle value; and
transforming the second video frame base on the second tilt angle value.

17. The method according to claim 15, further comprising transforming the first video frame based on the first tilt angle value and transforming the second video frame base on the second tilt angle value.

18. The method according to claim 15, wherein the tilt angle value comprises a tilt angle value that measures the tilt of the image sensor relative to the Earth's gravitational field.

19. The method according to claim 15, wherein the first tilt angle value is stored in the memory as metadata associated with the first video frame, and the second tilt angle value is stored in the memory as metadata associated with the second video frame.

20. The method according to claim 15, further comprising:
rotating the first video frame based on the first tilt angle value; and
rotating the second video frame based on the second tilt angle value.

21. The method according to claim 15, further comprising:
determining an average tilt angle value that is the average of the first tilt angle value and the second tilt angle value;
rotating the first video frame based on the average tilt angle value; and
rotating the second video frame based on the average tilt angle value.

22. A method comprising:
receiving a tilt value from an accelerometer;
determining a tilt angle value from the tilt value;
receiving a plurality of video frames from an image sensor; and
rotating each of the plurality of video frames based on the tilt angle value.

23. The method according to claim 22, wherein the tilt value comprises an acceleration value.

24. The method according to claim 22, wherein the plurality of video frames includes a first subset of video frames that are received prior to the other video frames; and wherein the tilt value is received while one or more of the first subset of video frames is received from the image sensor.

25. The method according to claim 22, wherein the tilt value comprises an average acceleration value of a plurality of acceleration values.

26. The method according to claim 22, wherein the tilt value comprises a filtered acceleration value of a plurality of acceleration values.
